(19) United States
(12) Patent Application Publication
(10) Pub. No.: US 2015/0082027 A1
(43) Pub. Date: Mar. 19, 2015

(54) DRM METHOD AND DRM SYSTEM FOR SUPPORTING OFFLINE SHARING OF DIGITAL CONTENTS

(71) Applicants: Peking University Founder Group Co., Ltd., Beijing (CN); Founder Information Industry Group, Beijing (CN); Founder Apabi Technology Limited, Beijing (CN)

(72) Inventors: Jingshan Ma, Beijing (CN); Li Ding, Beijing (CN)

(73) Assignees: Peking University Founder Group Co., Ltd., Beijing (CN); Founder Information Industry Group, Beijing (CN); Founder Apabi Technology Limited, Beijing (CN)

(21) Appl. No.: 14/095,831

(22) Filed: Dec. 3, 2013

(30) Foreign Application Priority Data
Sep. 16, 2013 (CN) 201310421420.2

(51) Int. Cl. G06F 21/10

(52) U.S. Cl. CPC G06F 21/10
USPC 713/156

(57) ABSTRACT

The present invention provides a DRM method and system for supporting offline sharing of digital resources. When a client applies for joining in a domain, the client sends its own device information to a server, and obtains feature data of the domain by receiving a sharing certificate sent by the server. Wherein, the sharing certificate is created by encrypting the feature data of the domain by using the equipment information of the client as a cipher. The client decrypts the sharing certificate by using its own equipment information to obtain the feature data. Since the feature data has already been obtained in the procedure of applying for joining the domain, a client is able to use the digital resources by using the feature data even if the client cannot connect to network, thus, an advantage of supporting offline sharing of digital resources is achieved.

### RELATED APPLICATIONS

The present application claims the benefit of priority to Chinese Patent Application No. 201310421420.2, filed on Sep. 16, 2013, which is herein expressly incorporated by reference in its entirety.

### TECHNICAL FIELD

The present invention relates to a DRM method and a DRM system, specifically relates to a DRM method and a DRM system for supporting the offline sharing of digital contents.

### BACKGROUND

It would be a big problem to a copyright owner for the digital resources (e.g. books, music, videos, games, etc.) created by the copyright owner being shared free. In order to solve the problem, DRM (digital rights management) technology raised. A traditional DRM technology bonds encrypted digital resources with a terminal equipment, so as to achieve the protection for a digital copyright. However, in such a digital copyright protection solution, it needs to issue a certificate for every digital resource of every client. Thus, a server for issuing certificates needs to create certificates by bonding equipment information of each of the clients with the key of the digital resource that the client requested to download; this causes a huge amount of work to the server. Besides, the certificates and digital resources cannot be shared among clients. In order to solve this problem, a DRM technology based on domain management appears.

A DRM system and a DRM method based on domain management is disclosed in the prior art, which comprises a server for sending a common domain certificate and multiple clients. The server firstly receives equipment information of all of the clients in a domain, creates certificates for the equipment information of all of the clients and a content key for encrypting the digital resources to obtain a common domain certificate that is available for all of the clients in the domain. Each of the clients in the domain decrypts the common domain certificate according to its own equipment information after received the common domain certificate, and obtain a content key for decrypting the digital resources. The client decrypts the received encrypted digital resources again according to the content key, so as to obtain a digital resource. This method solved the problem that a server has a huge amount of work and a certificate and a digital resource cannot be shared among the clients in the traditional DRM technology. However, it brings a new problem. When a change occurs to the clients in the domain, i.e. at each time when a client is added into the domain or leaves the domain, the server needs to recollect equipment information of all of the clients, recreate a common certificate for all of the current clients and send the common certificate to all of the clients in the domain. Therefore, the latest common certificate cannot be received by those clients that are not connected to network all the time. Thus, when the client downloads a new encrypted digital resource, the client cannot decrypt the newly downloaded encrypted digital resource since the client failed to receive the latest common certificate, which makes the client cannot use the digital resources normally.

### SUMMARY

Therefore, the technology problem to be solved by the present invention is to overcome the problem in the prior art, that is when the client has changed, a common certificate needs to be created for all of the current clients, those clients that are not connected to network all the time cannot use the digital resource normally because they did not receive the latest common certificate, thus a DRM method and a DRM system for supporting offline sharing of digital resources is provided.

In order to solve above-mentioned technology problem, the present invention provides a DRM method running in a server for supporting offline sharing of digital resources, comprising the following steps:

receiving a request for joining in a domain sent from a client, the request for joining in the domain comprising equipment information of the client;

creating a sharing certificate by encrypting feature data of the domain by using the equipment information of the client as a cipher, and sending the sharing certificate to a corresponding client.

The DRM method running in the server for supporting offline sharing of digital resources further comprises the following steps:

receiving a digital resource sharing request sent by a client in the domain, the digital resource sharing request comprising an ID of a digital resource being requested;

encrypting a digital key of the digital resource corresponding to the ID in the digital resource sharing request by using the feature data of the domain as a cipher, obtaining a first digital resource key, and sending the first digital resource key to the corresponding client.

The DRM method running in the server for supporting offline sharing of digital resources, further comprises steps for processing a digital resource monopolizing request sent by a client in the domain:

receiving a digital resource monopolizing request sent by the client, the digital resource monopolizing request comprising an ID of a digital resource being requested and the equipment information of the client;

obtaining a second digital resource key by encrypting the digital key of the digital resource corresponding to the ID by using the equipment information of the client as the cipher, and sending the second digital resource key to the corresponding client.

The DRM method running in the server for supporting offline sharing of digital resources, wherein the server comprises a certificate server and a digital resource server,

wherein the steps of creating a sharing certificate, receiving a digital resource sharing request, receiving a digital resource monopolizing request, creating a first digital resource key and a second digital resource key are completed in the certificate server; and

the step of sending the digital resource encrypted by the digital key according to the request from the client is completed in the digital resource server.

A DRM method running in a client for supporting offline sharing of digital resources comprises the following steps:

sending a request for joining in a domain to a server, the request for joining in a domain comprising equipment information of the client;

receiving a sharing certificate sent by the server, decrypting the sharing certificate by its own equipment information to obtain feature data of the domain.

The DRM method running in the client for supporting offline sharing of digital resources further comprises the following steps:

sending a digital resource sharing request to the server, the digital resource sharing request comprising an ID of a digital resource being requested;

receiving a first digital resource key corresponding to the digital resource sharing request from the server, decrypting the first digital resource key according to obtained feature data, obtaining a digital key of the digital resource corresponding to the digital resource sharing request;

receiving a requested digital resource encrypted by the digital key and sent by the server;

decrypting the digital resource according to the obtained digital key to obtain a digital resource that can be used directly.

The DRM method running in the client for supporting offline sharing of digital resources, wherein

receiving a digital resource sharing request sent by another client in the domain, sending the first digital resource key received from the server and a corresponding digital resource encrypted by the digital key to the client that sent the digital resource sharing request.

The DRM method running in the client for supporting offline sharing of digital resources further comprises the following steps:

sending a digital resource monopolizing request to the server, the digital resource monopolizing request comprising an ID of the digital resource being requested and equipment information of the client;

receiving a second digital resource key of the digital resource corresponding to the digital resource monopolizing request and sent by the server, decrypting the second digital resource key according to its own equipment information to obtain the digital key;

receiving a requested digital resource encrypted by the digital key and sent by the server;

decrypting the digital resource according to the obtained digital key to obtain a digital resource that can be used directly.

The DRM method for supporting offline sharing of digital resources further comprises the following steps for sharing verification before transmitting the first digital resource key and the corresponding digital resource between two clients, that is a first client and a second client:

sending, by the first client, a request for sharing the first digital resource key and the digital resource, to the second client;

encrypting, by the second client, a random number by using the feature data as a cipher to obtain a random check code, and sending the random check code to the first client;

receiving, by the first client, the random check code, if the feature data is stored on the first client, the first client decrypting the random check code by using the feature data to obtain a decrypted random number, and sending the decrypted random number to the second client; if the feature data is not stored in the first client, the first client exiting the verification;

receiving, by the second client, the decrypted random number sent by the first client, and comparing the decrypted random number with the random number sent by the second client, if they are the same, the second client sending the first digital resource key and the digital resource to the first client; if they are not the same, the verification being failed, the second client not sending the first digital resource key and the digital resource to the first client.

A DRM system running in a server for supporting offline sharing of digital resources, the server comprises:

a domain joining in unit, configured to receive a request for joining in a domain sent by a client, the request for joining in a domain comprising equipment information of the client;

a sharing certificate creating unit, configured to create a sharing certificate by encrypting feature data by using the equipment information of the client as a cipher, and send the sharing certificate to the corresponding client.

The DRM system running in the server for supporting offline sharing of digital resources, the server further comprises:

a digital resource sharing request receiving unit, configured to receive a digital resource sharing request sent by the client, the digital resource sharing request comprising an ID of the digital resource being requested;

a first digital resource key creating unit, configured to encrypt a digital key of the digital resource corresponding to the ID in the digital resource sharing request by using the feature data as the cipher, obtain a first digital resource key, and send the first digital resource key to a corresponding client.

The DRM system running in the server for supporting offline sharing of digital resources, the server further comprises:

a digital resource monopolizing request receiving unit, configured to receive a digital resources monopolizing request sent by the client, the digital resource monopolizing request comprising an ID of the digital resource being requested and the equipment information of the client;

a second digital resource key creating unit, configured to obtain a second digital resource key by encrypting the digital key of the digital resource corresponding to the ID by using the equipment information of the client as a cipher, and send the second digital resource key to the corresponding client.

The DRM system running in the server for supporting offline sharing of digital resources, wherein the server comprises a certificate server and a digital resource server, wherein,

the certificate server further comprises: a domain joining in unit, a sharing certificate creating unit, a digital resource sharing request receiving unit, a first digital resource key creating unit, a first digital resource key sending unit, a digital resource monopolizing request receiving unit, a second digital resource key creating unit and a second digital resource key sending unit;

the digital resource server further comprises: a digital resource storing unit and a digital resource sending unit.

A DRM system running in a client for supporting offline sharing of digital resources, the client comprises:

a domain joining in request unit, configured to send a request for joining in a domain to a server, the request for joining in a domain comprising equipment information of the client;

a sharing certificate receiving unit, configured to receive a sharing certificate sent by the server, decrypt the sharing certificate by its own equipment information to obtain feature data of the domain.

The DRM system running in the client for supporting offline sharing of digital resources, the client further comprises:

a digital resource sharing request sending unit, configured to send a digital resource sharing request to the server, the digital resource sharing request comprising an ID of the digital resource being requested;

a first digital resource key receiving unit, configured to receive a first digital resource key corresponding to the digital resource sharing request and sent by the server, decrypt the first digital resource key according to the obtained feature data, obtain a digital key of the digital resource corresponding to the digital resource sharing request;

a digital resource receiving unit, configured to receive a requested digital resource encrypted by the digital key and sent by the server;

a digital resource decrypting unit, configured to decrypt the digital resource according to the obtained digital key, and obtain a digital resource that can be used directly.

The DRM system running in the client for supporting offline sharing of digital resources, the client further comprises:

a client sharing unit, configured to receive a digital resource sharing request sent by another client in the domain, send the first digital resource key received from the server and a corresponding digital resource encrypted by using the digital key to the client that sent the digital resource sharing request.

The DRM system running in the client for supporting offline sharing of digital resources, the client further comprises:

a digital resource monopolizing request sending unit, configured to send a digital resource monopolizing request to the server, the digital resource monopolizing request comprising an ID of the digital resource being requested and equipment information of the client;

a second digital resource key receiving unit, configured to receive a second digital resource key of the digital resource corresponding to the digital resource monopolizing request and sent by the server, decrypt the second digital resource key according to its own equipment information to obtain the digital key.

The DRM system running in the client for supporting offline sharing of digital resources, the client further comprises:

a client sharing requesting unit, configured to make the first client send a request for sharing the first digital resource key and the digital resource to the second client;

a random check code creating unit, configured to make the second client encrypt a random number by using the feature data as a cipher to obtain a random check code, and send the random check code to the first client;

a random check code receiving unit, configured to make the first client receive the random check code, and if feature data is stored on the first client, decrypt the random check code by using the feature data to obtain a decrypted random number, and send the decrypted random number to the second client; if the feature data is not stored on the first client, exit the verification;

a verifying unit, configured to make the second client receive the decrypted random number sent by the first client, and compare the decrypted random number with the random number sent by the second client, if they are the same, the second client sending the first digital resource key and the digital resource to the first client; if they are not the same, the verification being failed, the second client not sending the first digital resource key and the digital resource to the first client.

Above-mentioned technical solutions of the present invention has the following advantages as compared with the prior art:

1. The present invention provides a DRM method and a DRM system for supporting offline sharing of digital resources, when the client applies for joining in the domain, it send its own device information to the server, and obtains the feature data of the domain by receiving the sharing certificate sent by the server. Wherein, the sharing certificate is created by encrypting the feature data of the domain by using the equipment information of the client as a cipher. The client obtains the feature data by decrypting the sharing certificate by using its own equipment information. Since the feature data has already been obtained in the procedure of applying for joining the domain, a client may use the digital resources by using the feature data even if the client cannot connect to network, thus, an advantage of supporting offline sharing of digital resources is achieved.

2. A DRM method and a DRM system for supporting offline sharing of digital resources of the present invention is provided, the client applies for joining in a domain, and obtains feature data of the domain by receiving a sharing certificate sent by a server; the server receives a digital resource sharing request sent by the client according to a user's requirement, the server sends a corresponding first digital resource key including a digital key and a corresponding encrypted digital resource to the client; the client receives the first digital resource key and the corresponding digital resource, decrypts the first digital resource key according to the obtained feature data to obtain a digital key, then decrypts the digital resource by using the digital key to obtain a digital resource that can be used directly; the resource sharing among the clients in the domain may also be achieved by sharing the first digital resource key and the corresponding digital resource encrypted by the digital key. The server in an embodiment of the present invention sends feature data of the domain to all of the clients in the domain, makes the client decrypt the first digital resource key by using the feature data to obtain a digital key, then decrypt the digital resource according to the obtained digital key, thus to manage the digital copyright efficiently. When a certain client in the domain cannot connect to network, the sharing of the digital resource is achieved by receiving a first digital resource key and digital resource of other clients in the domain, therefore, the present invention has an advantage of supporting offline sharing of digital resources.

3. A DRM method and a DRM system for supporting offline sharing of digital resources of the present invention may further achieve digital resource monopolizing, the client sends a digital resource monopolizing request to the server; the server assigns a second digital resource key to the client according to the digital resource monopolizing request, and send the corresponding digital resource to the client, wherein the second digital resource key is obtained by encrypting the corresponding digital key by using the equipment information of the client that sent the digital resource monopolizing request as a cipher. The client receives the second digital resource key and the digital resource, decrypts the second digital resource key by its own equipment information to obtain a digital key, then decrypts the digital resource by the digital key. The present invention has a scheme of distinguishing the resource sharing and the resource monopolizing, which makes it - possible to provide a service to monopolize a digital resource for a senior user, and efficiently prevent the digital resource from being used by an unauthorized user.

4. A DRM method and a DRM system for supporting offline sharing of digital resources of the present invention is provided, the server further comprises a certificate server and a digital resource server, the certificate server is configured to process operations on the certificate, the digital resource server is configured to store digital resources and send the digital resources to the client that made a request. Since the certificate server mainly implements processing operations, the digital resource server mainly stores the digital resource, therefore the present invention adopts a scheme of separating the certificate server and the digital resource server, so that an administrator may maintain the system according to the server's operations. Before sharing the resources among the clients in the domain, there is a step of verifying the identification, which may effectively prevent the digital resource from being used by an unauthorized user.

### BRIEF DESCRIPTION OF THE DRAWINGS

In order to understand the content of the present invention clearly, embodiments according to the present invention will be further described in details in the following with reference to the attached drawings, wherein:

FIG. 1 is a schematic diagram illustrating the structure of a system according to an embodiment of the present invention;

FIG. 2 is a flowchart diagram showing a DRM method running in a server for supporting offline sharing of digital resources according to an embodiment of the present invention;

FIG. 3 is a flowchart diagram showing a DRM method running in a client for supporting offline sharing of digital resources according to an embodiment of the present invention.

### DETAILED DESCRIPTION

A detailed description of the embodiment of the present invention will be presented with reference to the attached drawings. It can be understood that the embodiment described herein is only used for illustrating and explaining the present invention, and not tends to restrict the present invention in any way.

### Embodiment 1

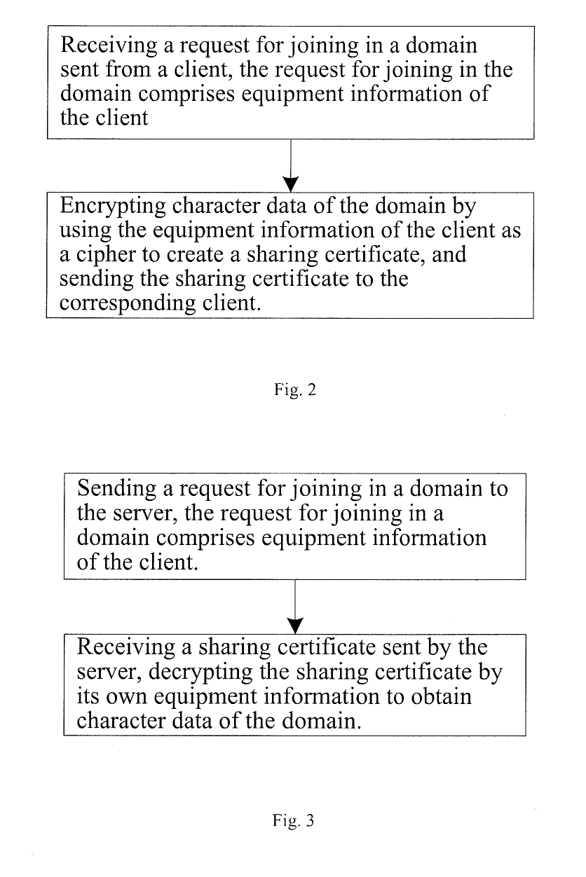

As an embodiment of the present invention, as shown in FIG. 2, a DRM method running in a server for supporting offline sharing of digital resources comprises following the steps:

The server receives a request for joining in a domain sent by a client; the request for joining in a domain comprises equipment information of the client. As a specific embodiment, the sharing certificate may also comprise a privilege of sharing, such as the privilege of copying the digital resource, the privilege of adding annotations and a period of validity etc.

A sharing certificate is created by encrypting feature data by using the equipment information of the client as a cipher, and the sharing certificate is sent to the corresponding client. The equipment information could be a MAC address or a CPU identification code of the client. As a specific embodiment, the sharing certificate may also comprise a signature of the server, configured to prevent an unauthorized user from changing the sharing certificate.

The present invention provides a DRM method for supporting offline sharing of digital resources. When the client applies to join in the domain, it sends its own device information to the server, and obtains the characteristic data of the domain by receiving the sharing certificate sent by the server. Wherein, the sharing certificate is created by encrypting the feature data of the domain by using the equipment information of the client as a cipher. While using the sharing certificate, the client obtains the feature data by decrypting the sharing certificate by using its own equipment information. Since the feature data has already been obtained in the procedure of applying for joining the domain, a client may use the digital resources by using the feature data even if the client cannot connect to network. Thus, an advantage of supporting offline sharing of digital resources is achieved.

### Embodiment 2

As an embodiment of the present invention, a DRM method running in the server for supporting offline sharing of digital resources, on the basis of embodiment 1, further comprises the following steps:

The server receives a digital resources sharing request sent by a client, the digital resources sharing request comprises an ID of the digital resource being requested; The ID is an unique code in the system, the ID corresponds to a digital resource, the digital resource is an electron book, video, audio, a game, etc.

The server encrypts a digital key of the digital resource corresponding to the ID in the digital resources sharing request by using the feature data as a cipher, to obtain a first digital resource key, and sends the first digital resource key to the corresponding client. As a specific embodiment, the first digital resource key may further comprise user privilege, a server signature, and so on.

The server stores the digital resource encrypted by the digital key. The digital key of each of the digital resources stored in the server is different from each other, so as to prevent the digital resource from being decrypted by a client not in the domain.

The server sends the digital resource, which is encrypted by the digital key and corresponding to the ID in the digital resource sharing request, to the corresponding client.

The server in an embodiment of the present invention sends feature data of the domain to all of the clients in the domain, makes the client decrypt the first digital resource key by using the feature data to obtain a digital key, then decrypts the digital resource according to the obtained digital key, thus to manage the digital copyright efficiently. When a certain client in the domain cannot connect to network, the sharing of the digital resource is achieved by receiving a first digital resource key and digital resource of other clients in the domain, therefore, an embodiment of the present invention has an advantage of supporting offline sharing of digital resources.

As another embodiment of the present invention, the method may further comprise a step of creating a domain: the server creating an empty domain, and creating feature data randomly for the domain. The feature data is a string of random number. As a specific embodiment, the server may also create a domain name for the domain while creating it.

### Embodiment 3

As an embodiment of the present invention, on the basis of embodiment 1 or embodiment 2, the method further comprises steps of processing a digital resource monopolizing request sent by a client in the domain.

The server receives a digital resource monopolizing request sent by the client, the digital resource monopolizing request comprises an ID of the digital resource being requested and equipment information of the client;

The server obtains a second digital resource key by encrypting the digital key of the digital resource corresponding to the ID by using the equipment information of the client as a cipher, and sends the second digital resource to the corresponding client.

The server stores the digital resource encrypted by the digital key.

The server sends the digital resource, which is encrypted by the digital key and corresponding to the ID in the digital resource sharing request to the corresponding client.

The client sends a digital resource monopolizing request to the server; the server assigns a second digital resource key to the client according to the digital resource monopolizing request, and sends the corresponding digital resource to the client, wherein the second digital resource key is obtained by encrypting the corresponding digital key by using the equipment information of the client that sent the digital resource monopolizing request. The client receives the second digital resource key and digital resources, decrypts the second digital resource key by using its own device information to obtain a digital key, and decrypts the digital resources by using the digital key. The present invention has a scheme of distinguishing the resource sharing and the resource monopolizing, which makes it possible to provide a service to monopolize a digital resource for a senior user, and efficiently prevent the digital resource from being used by an unauthorized user.

### Embodiment 4

As an embodiment of the present invention, on the basis of embodiment 3, the server further comprises a certificate server and a digital resource server. Wherein,

Operations in the certificate server includes a step of creating a domain; a step of creating a sharing certificate; a step of receiving a digital resource sharing request, a step of receiving a digital resource monopolizing request; a step of creating the first digital resource key and the second digital resource key.

The operations in the digital resource server include a step of storing the digital resource, a step of sending the digital resource according to the client's request. An embodiment of the present invention adopts a scheme of separating the certificate server and the digital resource server, so as to make an administrator easily maintain the system according to server's operation.

As an embodiment of the present invention, the number of the certificate server in the system is one; the number of the digital resource server in the system is more than one. The certificate server and the digital resource servers may exchange data. Since the certificate server mainly processes the operation on the certificate, and the digital resource server mainly processes operations of storing and sending the digital resource, therefore, by adopting this scheme, it is possible to increase capability of storing digital resource while satisfying the processing speed of the system, without requiring each of the server to satisfy the high performance on processing and storing capability, thus to reduce the system costs.

### Embodiment 5

As an embodiment of the present invention, as shown in FIG. 3, a DRM method running in a client for supporting offline sharing of digital resources comprises following the steps:

The client sends a request for joining in a domain to a server, the request for joining in a domain comprises equipment information of the client. After the server received the request for joining in a domain sent by the client, the server encrypts the feature data by using the equipment information of the client as a cipher to create a sharing certificate, sends the sharing certificate to the corresponding client.

The client receives the sharing certificate sent by the server, decrypts the sharing certificate by its own equipment information to obtain feature data of the domain.

The client sends a digital resource sharing request to the server, the digital resource sharing request comprises an ID of the digital resource being requested and equipment information of the client. After the server received the digital resource sharing request sent by the client to the server, the server encrypts a digital key corresponding to the digital resource requested by the client by using the feature data to obtain a first digital resource key, and sends the first digital resource key to the client.

### Embodiment 6

As an embodiment of the present invention, a DRM method running in the client for supporting offline sharing of digital resources, on the basis of embodiment 5, further comprises the following steps:

The client sends a digital resource sharing request to the server, the digital resource sharing request comprises an ID of the digital resource being requested and equipment information of the client. After the server received the digital resource sharing request sent by the client to the server, the server encrypts a digital key corresponding to the digital resource requested by the client by using the feature data to obtain a first digital resource key, and sends the first digital resource key to the client.

The client receives the first digital resource key corresponding to the digital resource sharing request send by the server, decrypts the first digital resource key according to the obtained feature data, to obtain a digital key of the digital resource corresponding to the digital resource sharing request.

The client receives the requested digital resource encrypted by the digital key from the server.

The client decrypts the digital resource according to the obtained digital key to obtain a digital resource that can be used directly.

### Embodiment 7

As an embodiment of the present invention, on the basis of embodiment 6, the client receives a digital resource sharing request sent by another client in the domain, sends the first digital resource key received from the server and a corresponding digital resource encrypted by using the digital key to the client that sent the digital resource sharing request. After the client that sent the digital resource sharing request received the first digital resource key and the corresponding digital resource that has been encrypted by the digital key, the client decrypts the first digital resource key according to the feature data stored in the client to obtain the digital key, then decrypts the corresponding digital resource by the digital key, thereby the digital resource that can be used directly can be obtained, which achieved sharing the digital resource among different clients in the same domain.

### Embodiment 8

As an embodiment of the present invention, on the basis of embodiment 6 or 7, the following steps are also included:

The client sends a digital resource monopolizing request to the server, the digital resource monopolizing request comprises an ID of the digital resource being requested and equipment information of the client.

The client receives a second digital resource key of the digital resource corresponding to the digital resource monopolizing request sent by the server, decrypts the second digital resource key according to its own equipment information to obtain the digital key.

The client receives the requested digital resource encrypted by the digital key from the server.

The client decrypts the digital resource according to the obtained digital key to obtain a digital resource that can be used directly.

### Embodiment 9

As an embodiment of the present invention, on the basis of embodiment 7, before transmitting the first digital resource key and the corresponding digital resource between two clients, the following steps of sharing verification are also included, wherein:

A first client sends a request for sharing the first digital resource key and the digital resource to a second client.

The second client encrypts a random number by using the feature data as a cipher to obtain a random check code, and sends the random check code to the first client;

The first client receives the random check code. If feature data is stored on the first client, the first client decrypts the random check code by using the feature data to obtain a decrypted random number, and sends the decrypted random number to the second client; if the feature data is not stored in the first client, the first client exits the verification.

After the second client receives the decrypted random number sent by the first client, the second client compares the decrypted random number with the random number sent by the second client, if they are the same, the second client sends the first digital resource key and the digital resource to the first client; if they are not the same, the verification is failed, the second client will not send the first digital resource key and the digital resource to the first client.

Before sharing the resources among the clients in the domain, there is further included a step of verifying identification, which may effectively prevent the digital resource from being used by an unauthorized user.

### Embodiment 10

As an embodiment of the present invention, a DRM system running in a server for supporting offline sharing of digital resources is provided, the server comprises:

A domain joining in unit, configured to receive a request for joining in a domain sent by a client, the request for joining in a domain comprising equipment information of the client.

A sharing certificate creating unit, configured to create a sharing certificate by encrypting feature data by using the equipment information of the client as a cipher, and send the sharing certificate to the corresponding client.

### Embodiment 11

As an embodiment of the present invention, on the basis of embodiment 10, said server further comprising:

A digital resource sharing request receiving unit, configured to receive a digital resource sharing request sent by the client, the digital resource sharing request comprising an ID of the digital resource being requested.

A first digital resource key creating unit, configured to encrypt a digital key of the digital resource corresponding to the ID in the digital resource sharing request by using the feature data as the cipher, to obtain a first digital resource key, and send the first digital resource key to the corresponding client.

A first digital resource storing unit, configured to store the digital resource encrypted by the digital key.

A first digital resource sending unit, configured to send the digital resource, which is encrypted by the digital key and corresponding to the ID in the digital resource sharing request, to the corresponding client.

As another embodiment of the present invention, the server may further includes: a domain creating unit, configured to create an empty domain, and randomly create feature data for this domain.

### Embodiment 12

As an embodiment of the present invention, on basis of embodiment 11, said server further comprises:

A digital resource monopolizing request receiving unit, configured to receive a digital resources monopolizing request sent by the client, the digital resource monopolizing request comprises an ID of the digital resource being requested and the equipment information of the client;

A second digital resource key creating unit, configured to obtain a second digital resource key by encrypting the digital key of the digital resource corresponding to the ID by using the equipment information of the client as a cipher, and send the second digital resource key to the corresponding client.

A second digital resource storing unit, configured to store the digital resource encrypted by the digital key.

A second digital resource sending unit, configured to send the digital resource, which is encrypted by the digital key and corresponding to the ID in the digital resource monopolizing request, to the corresponding client.

### Embodiment 13

As an embodiment of the present invention, on basis of embodiment 12, the server further comprises a certificate server and a digital resource server, wherein,

The certificate server further comprises: a domain joining in unit, a sharing certificate creating unit, a digital resource sharing request receiving unit, a first digital resource key creating unit, a first digital resource key sending unit, a digital resource monopolizing request receiving unit, a second digital resource key creating unit and a second digital resource key sending unit.

The digital resource server further comprises: a digital resource storing unit and a digital resource sending unit.

### Embodiment 14

As an embodiment of the present invention, a DRM system running in the client for supporting offline sharing of digital resources is provided, the client comprises:

A domain joining in request unit, configured to send a request for joining in a domain to a server, the request for joining in a domain comprising equipment information of the client.

A sharing certificate receiving unit, configured to receive a sharing certificate sent by the server, decrypt the sharing certificate by its own equipment information to obtain feature data of the domain.

### Embodiment 15

As an embodiment of the present invention, on basis of embodiment 14, said client further comprises:

A digital resource sharing request sending unit, configured to send a digital resource sharing request to the server, the digital resource sharing request comprises an ID of the digital resource being requested and equipment information of the client.

A first digital resource key receiving unit, configured to receive a first digital resource key corresponding to the digital resource sharing request and sent by the server, decrypt the first digital resource key according to the obtained feature data, obtain a digital key of the digital resource corresponding to the digital resource sharing request.

A first digital resource receiving unit, configured to receive a requested digital resource encrypted by using the digital key and sent by the server.

A first digital resource decrypting unit, configured to decrypt the digital resource according to the obtained digital key, and obtain a digital resource that can be used directly.

### Embodiment 16

As an embodiment of the present invention, on basis of embodiment 15, said client further comprises:

A client sharing unit, configured to receive a digital resource sharing request sent by another client in the domain, send the first digital resource key received from the server and a corresponding digital resource encrypted by using the digital key to the client that sent the digital resource sharing request.

### Embodiment 17

As an embodiment of the present invention, on basis of embodiment 15 or 16, said client further comprises:

A digital resource monopolizing request sending unit, configured to send a digital resource monopolizing request to the server, the digital resource monopolizing request comprises an ID of the digital resource being requested and equipment information of the client.

A second digital resource key receiving unit, configured to receive a second digital resource key of the digital resource corresponding to the digital resource monopolizing request from the server, decrypt the second digital resource key according to its own equipment information to obtain a digital key;

A second digital resource receiving unit, configured to receive a requested digital resource encrypted by using the digital key and sent by the server;

A second digital resource decrypting unit, configured to decrypt the digital resource according to the obtained digital key, and obtain a digital resource that can be used directly.

### Embodiment 18

As an embodiment of the present invention, on basis of embodiment 16, said client further comprises:

A client sharing request unit, configured to make the first client send a request for sharing the first digital resource and the digital resource to the second client.

A random check code creating unit, configured to make the second client encrypt a random number by using the feature data as a cipher to obtain a random check code, and send the random check code to the first client.

A random check code receiving unit, configured to make the first client receive the random check code, and if feature data is stored on the first client, decrypt the random check code by using the feature data to obtain a decrypted random number, and send the decrypted random number to the second client; if the feature data is not stored on the first client, exit the verification.

A verifying unit, configured to make the second client receive the decrypted random number sent by the first client, and compare the decrypted random number with the random number sent by the second client, if they are the same, the second client sending the first digital resource key and the digital resource to the first client; if they are not the same, the verification being failed, the second client not sending the first digital resource key and the digital resource to the first client.

### Embodiment 19

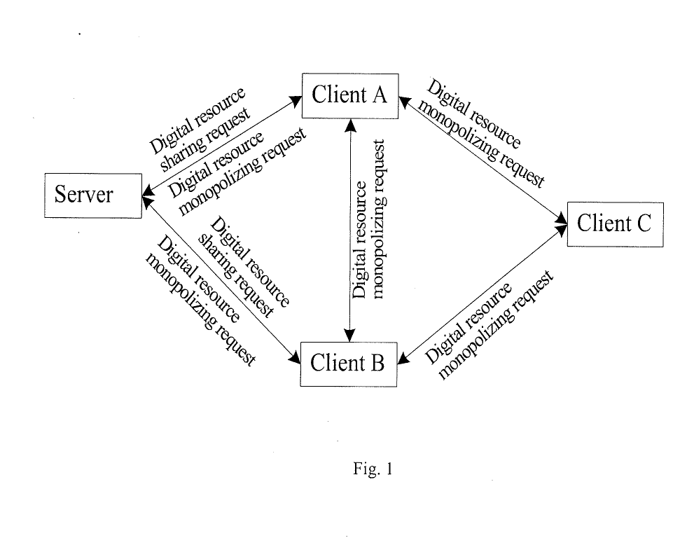

As an embodiment of the present invention, in order to describe the system from a view of a whole system, as shown in FIG. 1, the DRM system for supporting offline sharing of digital resources includes a server, client A, client B and client C.

The server firstly creates an empty domain, and randomly creates feature data for this domain.

Each of client A, client B and client C sends a request for joining in a domain to the server, each of the three requests for joining in a domain contains equipment information of the corresponding one of the three clients.

The server receives the three requests for joining in a domain, encrypts the feature data by using the equipment information of the clients requesting for joining in a domain as a cipher respectively, so as to create three sharing certificates, and sends each of the three sharing certificates to the corresponding one of client A, client B and client C.

The client A, client B and client C receives the corresponding sharing certificate sent by the server, decrypts the sharing certificates by their own equipment information respectively to obtain feature data of the domain.

In the case that client A and client B are connected to network, client A and client B can obtain the first digital resource key and the corresponding digital resource by sending the digital resource sharing request to the server. Besides, client A and client B can obtain the second digital resource key and the corresponding digital resource by sending the digital resource monopolizing request to the server. Client A and client B may also share the first digital resource key and the corresponding digital resource by sending the digital resource sharing request to each other.

While client C is in an offline state, since client C cannot directly apply the server for the first digital resource key and/or the second digital resource key, client C cannot obtain the resource from the server directly. At this time, client C can share the first digital resource key and the corresponding digital resource by sending the digital resource sharing request to client A or client B. When client C is in an online state, client C can also obtain the resource from the server in the same way as client A and client B. When the client C is in an offline state, the client C cannot communication with the server directly, thus cannot obtain the second digital resource key. Since the second digital resource key is created by encrypting the digital key by using equipment information of the client C, the client C cannot decrypt the second digital resource key by its own equipment information. Therefore, when being in an offline state, the client C cannot use the function of monopolizing the digital resource.

It should be understood by a person skilled in the field that, the embodiment of the present invention may be provided as a method, a system or a computer program product. Therefore, the present invention may adopt the forms of an entire hardware embodiment, an entire software embodiment or an embodiment combining software and the hardware. Furthermore, the present invention may adopt the form of a computer program product, embodied on one or more computer executable storage medium (including, but not limited to disk storage, CD-ROM, optic storage, etc.) containing computer executable program codes.

The present invention is described with reference to the flow chart diagrams and/or block diagrams of the method, device (system) and computer program product according to an embodiment of the present invention. It should be understood that computer program instructions may implement each of the work flows and/or blocks in the flow chart diagrams and/or the block diagrams, and the combination of the work flows and/or blocks in the flow chart diagrams and/or the block diagrams. These computer program instructions may be provided to a common computer, a dedicate computer, an embedded processer or a processor in other programmable data processing devices to create a machine, so that instructions executable by a processor of a computer or other programmable data processing devices create a device to achieve the functions assigned in one or more work flows in the flow chart diagram and/or one or more blocks in the block diagram.

These computer program instructions may also be stored in a computer readable storage that may guide a computer or other programmable data process devices to function in a certain way, so as the instructions stored in the computer readable storage create a production including an instruction unit, the instruction unit achieves the functions assigned in one or more flows in the flow chart diagram and/or one or more blocks in the block diagram.

These computer program instructions may also be loaded in a computer or other programmable data process devices, so that a series of operation steps are executed on the computer or other programmable devices to create processes achieved by the computer. Therefore, the instructions executed in the computer or other programmable devices provide the steps for achieving the function assigned in one or more flows in the flow chart diagram and/or one or more blocks in the block diagram.

Although preferred embodiments of the present invention have been described, it is understood that once a person skilled in the art knows the basic creative conception, he may make improvements and modifications to these embodiments. Thus, the accompanying claims tends to he explained as including the preferred embodiments as well as all the improvements and modifications that fall in the scope of the present invention.

What is claimed is:

1. A Digital Rights Management (DRM) method running in a server for supporting offline sharing of digital resources, comprising the following steps:
receiving a request for joining in a domain sent from a client, the request for joining in the domain comprising equipment information of the client; and
creating a sharing certificate by encrypting feature data of the domain by using the equipment information of the client as a cipher, and sending the sharing certificate to a corresponding client.

2. The DRM method running in the server for supporting offline sharing of digital resources according to claim 1, further comprising the following steps:
receiving a digital resource sharing request sent by a client in the domain, the digital resource sharing request comprising an ID of a digital resource being requested; and
encrypting a digital key of the digital resource corresponding to the ID in the digital resource sharing request by using the feature data of the domain as a cipher, obtaining a first digital resource key, and sending the first digital resource key to the corresponding client.

3. The DRM method running in the server for supporting offline sharing of digital resources according to according to claim 1, further comprising steps for processing a digital resource monopolizing request sent by a client in the domain:
receiving a digital resource monopolizing request sent by the client, the digital resource monopolizing request comprising an ID of a digital resource being requested and the equipment information of the client; and
obtaining a second digital resource key by encrypting the digital key of the digital resource corresponding to the ID by using the equipment information of the client as the cipher, and sending the second digital resource key to the corresponding client.

4. The DRM method running in the server for supporting offline sharing of digital resources according to claim 3, wherein the server comprises a certificate server and a digital resource server,
wherein the steps of creating a sharing certificate, receiving a digital resource sharing request, receiving a digital resource monopolizing request, creating a first digital resource key and a second digital resource key are completed in the certificate server; and
the step of sending the digital resource encrypted by the digital key according to the request from the client is completed in the digital resource server.

5. A DRM method running in a client for supporting offline sharing of digital resources, comprising the following steps:
sending a request for joining in a domain to a server, the request for joining in a domain comprising equipment information of the client; and
receiving a sharing certificate sent by the server, decrypting the sharing certificate by its own equipment information to obtain feature data of the domain.

6. The DRM method running in the client for supporting offline sharing of digital resources according to claim 5, further comprising the following steps:
sending a digital resource sharing request to the server, the digital resource sharing request comprising an ID of a digital resource being requested;
receiving a first digital resource key corresponding to the digital resource sharing request from the server, decrypting the first digital resource key according to obtained feature data, obtaining a digital key of the digital resource corresponding to the digital resource sharing request;
receiving a requested digital resource encrypted by the digital key and sent by the server; and
decrypting the digital resource according to the obtained digital key to obtain a digital resource that can be used directly.

7. The DRM method running in the client for supporting offline sharing of digital resources according to claim 6, further comprising:
receiving a digital resource sharing request sent by another client in the domain, sending the first digital resource key received from the server and a corresponding digital resource encrypted by the digital key to the client that sent the digital resource sharing request.

8. The DRM method running in the client for supporting offline sharing of digital resources according to claim 6, further comprising the following steps:
sending a digital resource monopolizing request to the server, the digital resource monopolizing request comprising an ID of the digital resource being requested and equipment information of the client;
receiving a second digital resource key of the digital resource corresponding to the digital resource monopolizing request and sent by the server, decrypting the second digital resource key according to its own equipment information to obtain the digital key;
receiving a requested digital resource encrypted by the digital key and sent by the server; and
decrypting the digital resource according to the obtained digital key to obtain a digital resource that can be used directly.

9. The DRM method for supporting offline sharing of digital resources according to claim 7, further comprising the following steps for sharing verification before transmitting the first digital resource key and the corresponding digital resource between a first client and a second client:
sending, by the first client, a request for sharing the first digital resource key and the digital resource, to the second client;
encrypting, by the second client, a random number by using the feature data as a cipher to obtain a random check code, and sending the random check code to the first client;
receiving, by the first client, the random check code, if the feature data is stored on the first client, the first client decrypting the random check code by using the feature data to obtain a decrypted random number, and sending the decrypted random number to the second client; if the feature data is not stored in the first client, the first client exiting the verification; and
receiving, by the second client, the decrypted random number sent by the first client, and comparing the decrypted random number with the random number sent by the second client, if they are the same, the second client sending the first digital resource key and the digital resource to the first client; if they are not the same, the verification being failed, the second client not sending the first digital resource key and the digital resource to the first client.

10. A DRM system running in a server for supporting offline sharing of digital resources, wherein, the server comprises:
a domain joining in unit, configured to receive a request for joining in a domain sent by a client, the request for joining in a domain comprising equipment information of the client; and
a sharing certificate creating unit, configured to create a sharing certificate by encrypting feature data by using the equipment information of the client as a cipher, and send the sharing certificate to a corresponding client.

11. The DRM system running in the server for supporting offline sharing of digital resources according to claim 10, wherein the server further comprises:
a digital resource sharing request receiving unit, configured to receive a digital resource sharing request sent by the client, the digital resource sharing request comprising an ID of the digital resource being requested; and
a first digital resource key creating unit configured to encrypt a digital key of the digital resource corresponding to the ID in the digital resource sharing request by using the feature data as the cipher, obtain a first digital resource key, and send the first digital resource key to the corresponding client.

12. The DRM system running in the server for supporting offline sharing of digital resources according to claim 10, wherein the server further comprises:
a digital resource monopolizing request receiving unit, configured to receive a digital resources monopolizing request sent by the client, the digital resource monopolizing request comprising an ID of the digital resource being requested and the equipment information of the client; and
a second digital resource key creating unit, configured to obtain a second digital resource key by encrypting the digital key of the digital resource corresponding to the ID by using the equipment information of the client as a cipher, and send the second digital resource key to the corresponding client.

13. The DRM system running in the server for supporting offline sharing of digital resources according to claim 12, wherein the server comprises a certificate server and a digital resource server, wherein,
the certificate server further comprises: a domain joining in unit, a sharing certificate creating unit, a digital resource sharing request receiving unit, a first digital resource key creating unit, a first digital resource key sending unit, a digital resource monopolizing request receiving unit, a second digital resource key creating unit and a second digital resource key sending unit; and
the digital resource server further comprises: a digital resource storing unit and a digital resource sending unit.

14. A DRM system running in a client for supporting offline sharing of digital resources, wherein, the client comprises:
a domain joining in request unit, configured to send a request for joining in a domain to a server, the request for joining in a domain comprising equipment information of the client; and
a sharing certificate receiving unit, configured to receive a sharing certificate sent by the server, decrypt the sharing certificate by its own equipment information to obtain feature data of the domain.

15. The DRM system running in the client for supporting offline sharing of digital resources according to claim 14, wherein the client further comprises:
a digital resource sharing request sending unit, configured to send a digital resource sharing request to the server, the digital resource sharing request comprising an ID of the digital resource being requested;
a first digital resource key receiving unit, configured to receive a first digital resource key corresponding to the digital resource sharing request and sent by the server, decrypt the first digital resource key according to the obtained feature data, obtain a digital key of the digital resource corresponding to the digital resource sharing request;
a digital resource receiving unit, configured to receive a requested digital resource encrypted by the digital key and sent by the server; and
a digital resource decrypting unit, configured to decrypt the digital resource according to the obtained digital key, and obtain a digital resource that can be used directly.

16. The DRM system running in the client for supporting offline sharing of digital resources according to claim 15, wherein the client further comprises:
a client sharing unit, configured to receive a digital resource sharing request sent by another client in the domain, send the first digital resource key received from the server and a corresponding digital resource encrypted by using the digital key to the client that sent the digital resource sharing request.

17. The DRM system running in the client for supporting offline sharing of digital resources according to claim 15, wherein the client further comprises:
a digital resource monopolizing request sending unit, configured to send a digital resource monopolizing request to the server, the digital resource monopolizing request comprising an ID of the digital resource being requested and equipment information of the client; and
a second digital resource key receiving unit, configured to receive a second digital resource key of the digital resource corresponding to the digital resource monopolizing request and sent by the server, decrypt the second digital resource key according to its own equipment information to obtain the digital key.

18. The DRM system running in the client for supporting offline sharing of digital resources according to claim 16, wherein the client further comprises:
a client sharing requesting unit, configured to make the first client send a request for sharing the first digital resource key and the digital resource to the second client;
a random check code creating unit, configured to make the second client encrypt a random number by using the feature data as a cipher to obtain a random check code, and send the random check code to the first client;
a random check code receiving unit, configured to make the first client receive the random check code, and if feature data is stored on the first client, decrypt the random check code by using the feature data to obtain a decrypted random number, and send the decrypted random number to the second client; if the feature data is not stored on the first client, exit the verification; and
a verifying unit, configured to make the second client receive the decrypted random number sent by the first client, and compare the decrypted random number with the random number sent by the second client, if they are the same, the second client sending the first digital resource key and the digital resource to the first client; if they are not the same, the verification being failed, the second client not sending the first digital resource key and the digital resource to the first client.
